(19) United States
(12) Patent Application Publication
(10) Pub. No.: US 2026/0171942 A1
(43) Pub. Date: Jun. 18, 2026

(54) MOTOR SPEED CONTROL DEVICE

(71) Applicants: KABUSHIKI KAISHA TOSHIBA, Kawasaki-shi (JP); Meiji University, Tokyo (JP)

(72) Inventors: Ryosuke MORITA, Kawasaki (JP); Sari MAEKAWA, Kawasaki (JP); Takeshi SHIBAYAMA, Yokohama (JP); Toshimitsu AIZAWA, Yokohama (JP)

(73) Assignees: KABUSHIKI KAISHA TOSHIBA, Kawasaki-shi (JP); Meiji University, Tokyo (JP)

(21) Appl. No.: 19/400,302

(22) Filed: Nov. 25, 2025

(30) Foreign Application Priority Data
Dec. 18, 2024 (JP) 2024-221724

(51) Int. Cl. H02P 21/18; H02P 21/22

(52) U.S. Cl. CPC H02P 21/18; H02P 21/22

(57) ABSTRACT

A motor speed control device in an embodiment includes: an electric power converter that includes a plurality of semiconductor switching elements and that converts direct-current power into alternating-current power to supply the alternating-current power to an alternating-current motor; a current detector that detects a current that is supplied to the alternating-current motor; a speed detector that detects a speed of the alternating-current motor; and a controller that controls turning-on and turning-off of the plurality of semiconductor switching elements, in which: the controller includes a speed controller that generates a command current based on a deviation between an input command speed and the detected speed, and a current controller that generates a command voltage based on a deviation between the command current and the detected current; and the speed controller computes a command current for each control period and outputs the command current to the current controller, the command current being a command current for causing the speed of the alternating-current motor to follow a target speed in a control period after a plurality of control periods from a present control period, and being computed by evaluating a sum of a command current computed last time and an adjustment current computed this time.

### BACKGROUND OF THE INVENTION

### Field of the Invention

An embodiment of the present invention relates to a device and method for controlling the speed of a motor.

### Description of the Related Art

In the field of a variable-speed AC motor, presently, a permanent magnet synchronous motor (PMSM) has been widely used, because of its characteristics such as high efficiency and high torque density. As for the PMSM, it is desirable that the stabilization time of a control system can be easily designed so as to be short in an application that requires high responsiveness, as exemplified by a servo system. As a control scheme that realizes the desires, there is a deadbeat (DB) control. The DB control is a technique in which the deviation of a controlled variable is completely stabilized at zero in a finite control period. In recent years, the DB control has been applied to the current control of the PMSM, as shown in Patent Literature 1 (Japanese Patent Laid-Open No. 2019-83673) for example.

However, under present circumstances, the application of the DB control to the speed control has not been sufficiently studied. An existing DB control that is used for the current control is generally a technique for minimal time stabilization, and is realized by simply solving an inverse system for a control object. This is because a current detection signal has an analog value, the use of an A/D converter allows a sufficiently high response to the variation in current in one control period, and the signal can be detected with high resolution.

Meanwhile, in the case where a rotary encoder is used, the speed is calculated based on the timing of the detection of a pulse signal that is output by the rotary encoder, and therefore, the responsiveness and accuracy of the detection are restricted by the rotation speed of the motor, the position resolution of a sensor, and the clock frequency of a computing device. Therefore, under present circumstances, conditions with which the same approach as that in the DB current control can be applied are limited in the speed control of the motor.

### BRIEF DESCRIPTION OF THE DRAWINGS

FIG. 1 is a functional block diagram showing the configuration of a motor speed control device in a first embodiment;

FIG. 2 is a functional block diagram showing the detailed configuration of a speed controller;

FIG. 3 is a time chart showing a speed step response by an ideal minimal time DB speed control;

FIG. 4 is a time chart showing a speed step response by a DB speed control in the embodiment;

FIG. 5 is a diagram showing simulation conditions and motor constants;

FIG. 6 is a diagram showing a speed step response and command values and actual currents about a q-axis current in the case of n_{c}=4;

FIG. 7 is a diagram corresponding to FIG. 6 in the case of n_{c}=40;

FIG. 8 is a diagram showing a speed step response by a conventional PI control and a speed step response by the embodiment in the case of n_{c}=40, in a side-by-side manner;

FIG. 9 is a diagram showing a case where a window function is a rectangular window and a case where the window function is a Hamming window in the case of n_{c}=40 in a second embodiment; and

FIG. 10 is a diagram showing a speed step response in the case where the window function is the Hamming window.

### DETAILED DESCRIPTION OF THE EMBODIMENT

Provided is a motor speed control device in which a DB control can be applied to the speed control of a motor.

A motor speed control device in an embodiment includes:
an electric power converter that includes a plurality of semiconductor switching elements and that converts direct-current power into alternating-current power to supply the alternating-current power to an alternating-current motor;
a current detector that detects a current that is supplied to the alternating-current motor;
a speed detector that detects a speed of the alternating-current motor; and
a controller that controls turning-on and turning-off of the plurality of semiconductor switching elements, in which
the controller includes
a speed controller that generates a command current based on a deviation between an input command speed and the detected speed, and
a current controller that generates a command voltage based on a deviation between the command current and the detected current; and
the speed controller computes a command current for each control period and outputs the command current to the current controller, the command current being a command current for causing the speed of the alternating-current motor to follow a target speed in a control period after a plurality of control periods from a present control period, and being computed by evaluating a sum of a command current computed last time and an adjustment current computed this time.

### First Embodiment

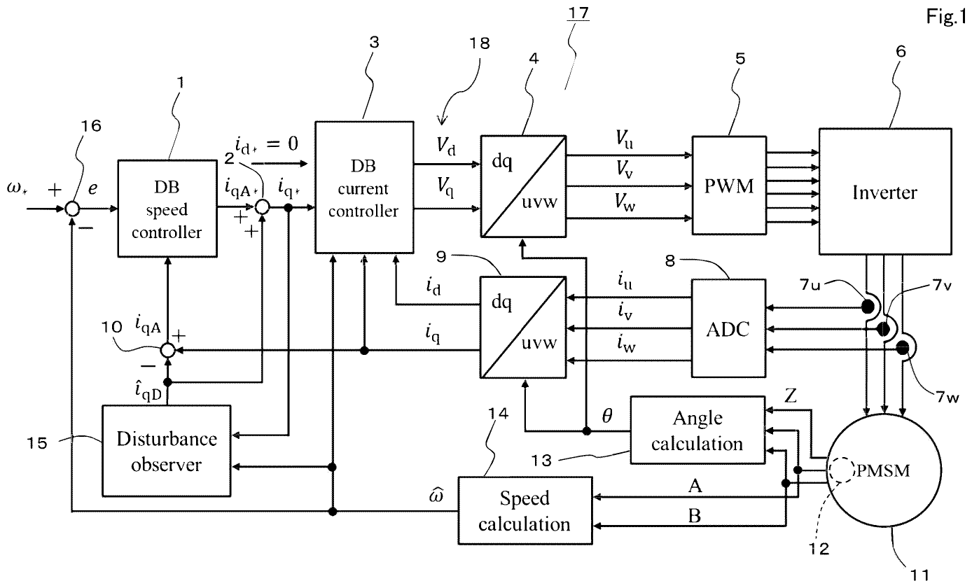

A first embodiment will be described below with reference to FIG. 1 to FIG. 8. In a block diagram shown in FIG. 1, each name of functional blocks is shown in English. To a speed controller 1, a deviation e between a command speed ω_{*} and a speed ωhat (\hat{ }) calculated by a speed calculator 14 is input through a subtracter 16. The symbol “\hat{ }” indicates that the value is an estimated value. Further, to the speed controller 1, an acceleration component i_{qA} of a q-axis current that is the difference between a q-axis current i_{q} output by a three-phase→dq coordinate converter 9 and an estimated q-axis disturbance current i_{qD}hat output by a disturbance observer 15 is input through a subtracter 10.

The speed controller 1 performs a speed DB control based on the above inputs, and as a result, outputs acceleration component i_{qA*} of a q-axis command current to an adder 2. In the adder 2, a result from adding the estimated q-axis disturbance current i_{qD}hat to the acceleration component i_{qA*} is output to a current controller 3 as a q-axis command current i_{q*}. To the current controller 3, the zero value is input as a d-axis command current i_{d*}. In addition, to the current controller 3, the q-axis current i_{q} and a d-axis current i_{d} that are output by the three-phase→dq coordinate converter 9, and the speed ωhat are input. The current controller 3 performs the current DB control based on the above inputs, and as a result, outputs a q-axis voltage V_{q} and a d-axis voltage V_{d} to a dq→three-phase coordinate converter 4.

To the dq→three-phase coordinate converter 4 and the three-phase→dq coordinate converter 9, an electric angle θ calculated by an angle calculator 13 is input. The dq→three-phase coordinate converter 4 converts the d-axis voltage Vd and the q-axis voltage Vq into three-phase voltages Vu, Vv, and Vw based on the electric angle θ, and outputs them to a PWM generator 5. The PWM generator 5 generates three-phase PWM signals U±, V±, and W±, and outputs them to an inverter 6 as gate signals.

The inverter 6 is an electric power converter, and although not specifically illustrated, for example, is configured by three-phase bridge connection of semiconductor switching elements such as power MOSFETs and IGBTs, as is commonly known. At respective phase output terminals of the inverter 6, current detectors 7u, 7v, and 7w are disposed, and respective phase currents iu, iv, and iw detected by the current detectors 7u, 7v, and 7w are input to the three-phase→dq coordinate converter 9, after the A/D conversion by an A/D converter 8.

The phase output terminals of the inverter 6 are connected to respective ends of phase windings of a PMSM 11 that is an alternating-current motor, respectively. The PMSM 11 incorporates a rotary encoder 12 that is a speed detector. The rotary encoder 12 generates signals in A-phase, B-phase, and Z-phase, with the rotation of a rotor of the PMSM 11, and outputs the signals to the angle calculator 13. To the speed calculator 14, the signals in A-phase and B-phase are input. The rotary encoder 12 and the speed calculator 14 correspond to the speed detector.

To the disturbance observer 15, the speed what calculated by the speed calculator 14 and the q-axis command current i_{q*} output by the adder 2 are input. The disturbance observer 15 computes and outputs the estimated q-axis disturbance current i_{qD}hat based on the input signals. The above members other than the PMSM 11 constitute the motor speed control device 17. Further, the members resulting from excluding the inverter 6, the current detector 7, and the rotary encoder 12 from the motor speed control device 17 constitute a controller 18.

Next, details of the control content in each functional block will be described. First, the DB current control will be described.

### <DB Current Control>

A voltage equation in a dq-axis rotation coordinate system for a general PMSM is expressed as Expression (1).

$$\begin{matrix}[ Formula 1 ] & \\ \{ \begin{matrix}{V}_{d} = {Ri}_{d} + {L}_{d} \frac{{di}_{d}}{dt} - ω {L}_{q} {i}_{q} \\ {V}_{d} = {Ri}_{q} + {L}_{q} \frac{{di}_{q}}{dt} + ω {L}_{d} {i}_{d} + ω ϕ\end{matrix} & \# ( 1 )\end{matrix}$$

R: winding resistance, Ld: d-axis inductance, Lq: q-axis inductance, ω: electric angle frequency, φ: maximal interlinkage flux of permanent magnet

By converting Expression (1) into a state equation, Expression (2) is obtained, and system matrices A and B in Expression (2) are expressed as Expression (3).

$$\begin{matrix}[ Formula 2 ] & \\ \frac{d}{dt} [ \begin{matrix}{i}_{d} \\ {i}_{q}\end{matrix} ] = A [ \begin{matrix}{i}_{d} \\ {i}_{q}\end{matrix} ] + B ( [ \begin{matrix}{V}_{d} \\ {V}_{q}\end{matrix} ] - [ \begin{matrix}0 \\ ω ϕ\end{matrix} ] ) & \# ( 2 )\end{matrix}$$

$$A = [ \begin{matrix}- \frac{R}{{L}_{d}} & \frac{{L}_{q} ω}{{L}_{d}} \\ - \frac{{L}_{d} ω}{{L}_{q}} & - \frac{R}{{L}_{q}}\end{matrix} ] , B = [ \begin{matrix}\frac{1}{{L}_{d}} & 0 \\ 0 & \frac{1}{{L}_{q}}\end{matrix} ] \qquad \# ( 3 )$$

In the state equation in Expression (2), an input is a value resulting from subtracting an inductive voltage from the voltage, and state variables are the d-axis current and the q-axis current. When the derived Expression (2) is discretized with respect to time k while the sampling period is T, Expression (4) is obtained. G and H in Expression (4) are expressed as Expression (5).

$$\begin{matrix}[ Formula 3 ] & \\ [ \begin{matrix}{i}_{k + 1}^{d} \\ {i}_{k + 1}^{q}\end{matrix} ] = G [ \begin{matrix}{i}_{k}^{d} \\ {i}_{k}^{q}\end{matrix} ] + HB ( [ \begin{matrix}{V}_{k}^{d} \\ {V}_{k}^{q}\end{matrix} ] - [ \begin{matrix}0 \\ {ω}_{k} ϕ\end{matrix} ] ) & \# ( 4 )\end{matrix}$$

$$G = {e}^{AT} , H = {\int }^{T} \text{?} {e}^{A τ} d τ \qquad \# ( 5 )$$

$$\text{?} \text{indicates text missing or illegible when filed}$$

As for matrix exponential function in Expression (5), an approximation is performed using a Maclaurin series, depending on a required discretization accuracy. A d-axis current i^{d}ₖ₊₁ and a q-axis current i^{q}ₖ₊₁ at time (k+1) are replaced with command values i^{d*}ₖ₊₁, i^{q*}ₖ₊₁, and solving is performed for the d-axis voltage and the q-axis voltage, so that a control law for deriving a voltage necessary for the current following in one period is obtained as Expression (6).

$$\begin{matrix}[ Formula 4 ] & \\ [ \begin{matrix}{V}_{k}^{d} \\ {V}_{k}^{q}\end{matrix} ] = {( HB )}^{- 1} ( \begin{matrix}{i}_{k + 1}^{d *} \\ {i}_{k + 1}^{q *}\end{matrix} ) - G [ \begin{matrix}{i}_{k}^{d} \\ {i}_{k}^{q}\end{matrix} ] ) + [ \begin{matrix}0 \\ {ω}_{k} ϕ\end{matrix} ] & \# ( 6 )\end{matrix}$$

By the above computation law, the d-axis current and the q-axis current completely follow the command values in one control period. In the above DB control, the robustness against errors of motor parameters is low, and therefore, it is desirable to apply a robust control scheme that is combined with an oversampling deadbeat control or a parameter estimation, as necessary.

### <Disturbance Observer 15>

In the case where a dq conversion is performed by a relative conversion, the motion equation of a general PMSM is given as Expression (7)

$$\begin{matrix}[ Formula 5 ] & \\ \frac{3}{2} P ϕ \vert {i}_{q} = \frac{J}{P} \frac{d ω}{dt} + \frac{D}{P} ω + {τ}_{L} & \# ( 7 )\end{matrix}$$

P: number of pole pairs, J: inertia, D: viscous friction coefficient, τ_{L}: load torque

A disturbance torque τ_{D} is defined as Expression (8).

$$\begin{matrix}[ Formula 6 ] & \\ {τ}_{D} = {τ}_{L} + \frac{D}{P} ω + \frac{J - \hat{J}}{P} \frac{d ω}{dt} + \frac{3 P ( ϕ - \hat{ϕ} )}{2} {i}_{q} & \# ( 8 )\end{matrix}$$

Jhat: inertia design value, φhat: permanent magnet flux design value

When the disturbance torque τ_{D} is converted into a q-axis disturbance current i_{qD} at i_{d}=0 without considering reluctance torque, Expression (9) is obtained.

$$\begin{matrix}[ Formula 7 ] & \\ {i}_{qD} = \frac{2}{3 P \hat{ϕ}} {τ}_{D} & \# ( 9 )\end{matrix}$$

When Expression (7) is deformed based on Expression (8) and Expression (9) using the q-axis current i_{qA}=i_{q}−i_{qD}, which is a value after the removal of a disturbance component and is proportional to the acceleration, the motion equation is simplified as shown in Expression (10).

$$\begin{matrix}[ Formula 8 ] & \\ \frac{2}{3} P \hat{ϕ} {i}_{qA} = \frac{\hat{J}}{P} \frac{d ω}{dt} & \# ( 10 )\end{matrix}$$

The q-axis disturbance current i_{qD} cannot be directly detected, and therefore, is derived based on Expression (11), in accordance with the principle of the disturbance observer.

$$\begin{matrix}[ Formula 9 ] & \\ {i}_{qD} = {i}_{q *} = \frac{2 \hat{J}}{3 {P}^{2} ϕ} \frac{d ω}{dt} & \# ( 11 )\end{matrix}$$

The disturbance current i_{qD} obtained by Expression (11) includes an estimated error due to noise, and therefore, is caused to pass through a low pass filter (LPF), so that the estimated q-axis disturbance current i_{qD}hat is used.

### <Minimal Time DB Speed Control>

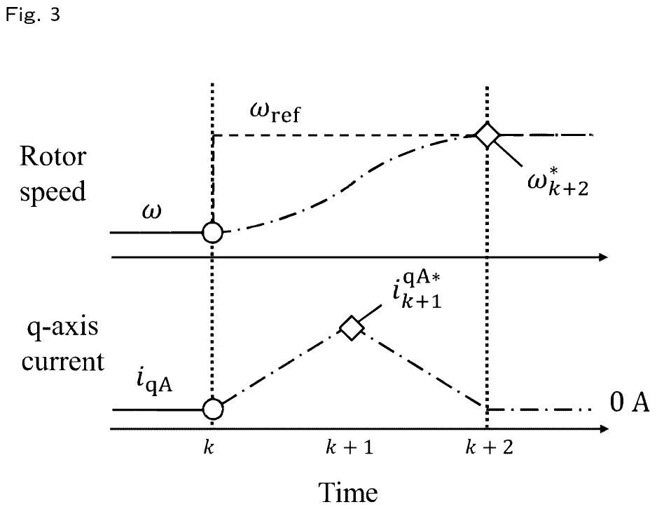

FIG. 3 shows a time chart showing a speed step response by an ideal minimal time DB speed control. In order that the pulsation of the speed does not occur between sample points and the speed follows the command value in the minimal time, a control is performed such that the speed and the current converge on steady-state values in two control periods, as shown in FIG. 3.

A control computation expression is derived by solving a discrete motion equation from time K to time (k+2). In the simplified motion equation (10), the q-axis current i_{qA} as an input changes in a short discrete period, in a linear function manner, and therefore, the motion equation is discretized by Tustin transform. By Tustin transform of Expression (10), Expression (12) is obtained.

$$\begin{matrix}[ Formula 10 ] & \\ \frac{3}{4} P \hat{ϕ} ( {i}_{k + 1}^{qA} + {i}_{k}^{qA} ) = \frac{\hat{J}}{PT} ( {ω}_{k + 1} - {ω}_{k} ) & \# ( 12 )\end{matrix}$$

As for Expression (12), when an expression after one control period is added, Expression (13) is obtained.

$$\begin{matrix}[ Formula 11 ] & \\ \frac{3}{4} P \hat{ϕ} ( {i}_{k + 2}^{qA} + 2 {i}_{k + 1}^{qA} + {i}_{k}^{qA} ) = \frac{\hat{J}}{PT} ( {ω}_{k + 2} - {ω}_{k} ) & \# ( 13 )\end{matrix}$$

The acceleration of the rotor becomes zero at time (k+2), and therefore, i^{qA}ₖ₊₂=0 is satisfied. Further, i^{qA}ₖ₊₁ and Ωₖ₊₂ are adopted as command values i^{qA*}ₖ₊₁ and ω^{*}ₖ₊₂, respectively.

When a speed deviation is eₖ=ω^{*}ₖ₊₂−ωₖ and solving is performed for i^{qA*}ₖ₊₁, a command current in the minimal time DB speed control is given as Expression (14).

$$\begin{matrix}[ Formula 12 ] & \\ {i}_{k + 1}^{qA *} = \frac{2 J}{3 ϕ {P}^{2} T} {e}_{k} - \frac{1}{2} {i}_{k}^{qA} & \# ( 14 )\end{matrix}$$

### <DB Speed Control in Embodiment>

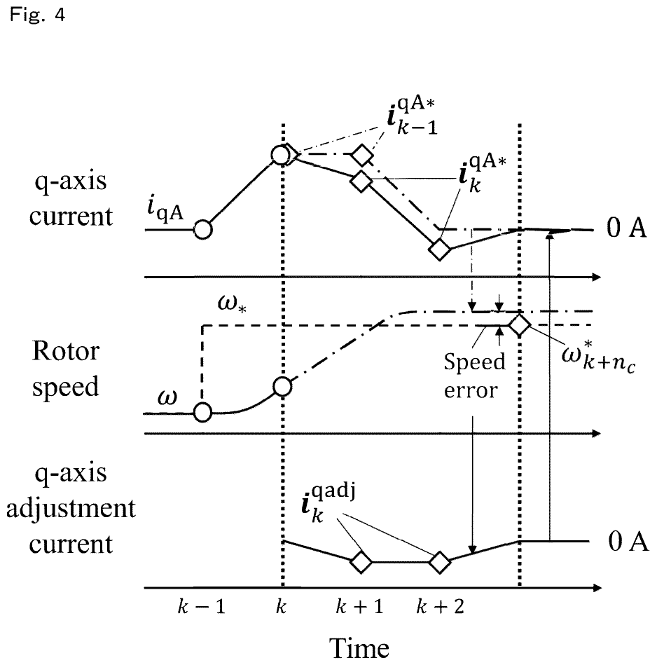

FIG. 4 shows a time chart of a speed step response by the DB speed control in the embodiment. In this figure, a target stabilization period n_{c} is three periods. The period in the speed control is ½ of a carrier period in a PWM control. In the initial condition, a temporal vector i^{qA*}ₖ₋₁ of a command current shown in Expression (M1) is given such that the command speed is changed stepwise at time (k−1) and is stabilized at time (k+2).

$$\begin{matrix}[ Formula 13 ] & \\ {i}_{k - 1}^{qA *} = {[ {i}_{k \vert k - 1}^{qA *} … {i}_{k + {n}_{c} - 2 \vert k - 1}^{qA *} ]}^{T} & \# ( M1 )\end{matrix}$$

The command current at time k takes over a command current vector given at time (k−1), and is computed by adding a shortfall of the current for the stabilization at a command speed ω^{*}_{k+nc}, to the command current vector i^{qA*}ₖ₋₁, as an adjustment current vector i^{qadj}ₖ shown in Expression (M2).

$$\begin{matrix}[ Formula 14 ] & \\ {i}_{k}^{qadj} = {[ {i}_{k + 1 \vert k}^{qadj} … {i}_{k + {n}_{c} - 1 \vert k}^{qadj} ]}^{T} & \# ( M2 )\end{matrix}$$

A specific computation expression is shown below. First, a discrete motion equation from time k to time (k+n_{c}) is derived. As for Expression (12), in (n_{c}−1) periods from time k, expressions for the respective periods are summed, and thereby, Expression (15) is obtained.

$$\begin{matrix}[ Formula 15 ] & \\ \frac{3}{4} P \hat{ϕ} ( {i}_{k + {n}_{c}}^{qA} + 2 {\sum }_{n = 1}^{{n}_{c} - 1} {i}_{k + n}^{qA} + {i}_{k}^{qA} ) = \frac{\hat{J}}{PT} ( {ω}_{k + {n}_{c}} - {ω}_{k} ) & \# ( 15 )\end{matrix}$$

The q-axis current converges on a steady-state value at time (k+n_{c}), and therefore, i^{qA}_{k+nc}=0 is satisfied. Further, i^{qA}ₖ is an element of a command value i^{qA*}ₖ at time k. Furthermore, Expression (15) is deformed while ω_{k+nc} is adopted as a command speed ω^{*}_{k+nc} and eₖ=ω^{*}_{k+nc}−ωₖ is adopted as the speed deviation, and thereby, Expression (16) is obtained.

$$\begin{matrix}[ Formula 16 ] & \\ {\sum }_{n = 1}^{{n}_{c} - 1} {i}_{k + n \vert k}^{qA} = \frac{2 \hat{J}}{3 {P}^{2} \hat{ϕ} T} {e}_{k} - \frac{1}{2} {i}_{k}^{qA} & \# ( 16 )\end{matrix}$$

Expression (16) expresses the sum of command currents necessary to stabilize the speed at time n_{c}. For realizing the DB speed control in the embodiment, the value of Expression (16) may be caused to coincide with the sum of a command current taken over from time (k−1) and an adjustment current at time k. Consequently, the sum of adjustment currents is given as Expression (17).

$$\begin{matrix}[ Formula 17 ] & \\ {\sum }_{n = 1}^{{n}_{c} - 1} {i}_{k + n \vert k}^{qadj} = {\sum }_{n = 1}^{{n}_{c} - 1} {i}_{k + n \vert k}^{qA *} - {\sum }_{n = 1}^{{n}_{c} - 2} {i}_{k + n \vert k - 1}^{qA *} & \# ( 17 )\end{matrix}$$

The adjustment current vector is shown as Expression (18) in the case where all elements have the same value.

$$\begin{matrix}[ Formula 18 ] & \\ {i}_{k}^{qadj} = {\sum }_{n = 1}^{{n}_{c} - 1} {i}_{k + n \vert k}^{qadj} \frac{1}{{n}_{c} - 1} [ \begin{matrix}1 \\ ⋮ \\ 1\end{matrix} ] & \# ( 18 )\end{matrix}$$

When the adjustment current vector obtained by Expression (18) is used, the command current vector at time k is updated by Expression (19). In the expression, U is a matrix in which the elements of the vector are shifted in the upward direction and the lowest element is set to 0, and is expressed as Expression (20). The command value that is output to the current controller 3 is the first element of i^{qA*}ₖ.

$$\begin{matrix}[ Formular 19 ] & \\ {i}_{k}^{qA *} = {Ui}_{k - 1}^{qA *} + {i}_{k}^{qadj} & \# ( 19 )\end{matrix}$$

$$U = [ \begin{matrix}0 & & 1 & & O \\ & & ⋱ & ⋱ & \\ & & & ⋱ & 1 \\ & O & & & \\ & & & & 0\end{matrix} ] \qquad \# ( 20 )$$

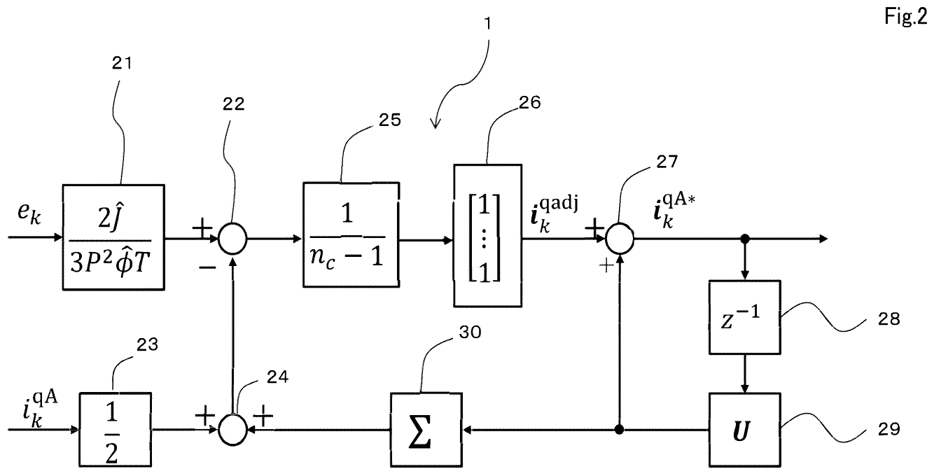

FIG. 2 shows a functional block that executes the computation in Expression (19), in the speed controller 1. The speed deviation eₖ is input to a multiplier 21, and is multiplied by the coefficient of the first term of the right-hand side in Expression (16). The multiplication result of the multiplier 21 is input to a minuend input of a subtracter 22. The q-axis current i^{qA}ₖ is input to a multiplier 23, and is multiplied by a coefficient “½”. The multiplication result of the multiplier 23 is input to an adder 24. The addition result of the adder 24 is input to a subtraction input of the subtracter 22.

The subtraction result of the subtracter 22 is input to a multiplier 25, to be multiplied by a coefficient “1/(n_{c}−1)”, and then is input to a multiplier 26, to be multiplied by a column vector in which all elements are “1”. The multiplication result of the multiplier 26 is the left-hand side in Expression (18), and is input to an adder 27. The addition result of the adder 27 is input to an accumulator 30 through a delay device 28 and a multiplier 29. In the multiplier 29, the multiplication by the matrix U shown in Expression (20) is performed. The accumulation result of the accumulator 30 is input to the adder 24.

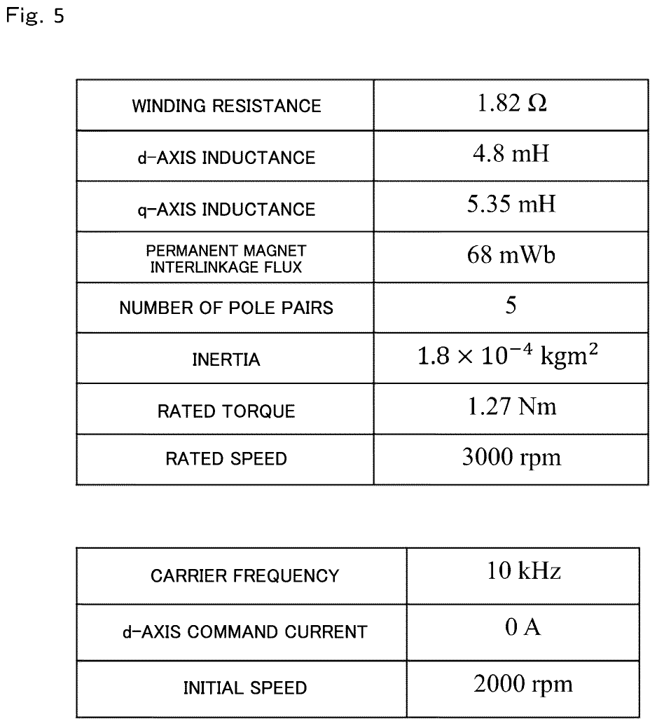

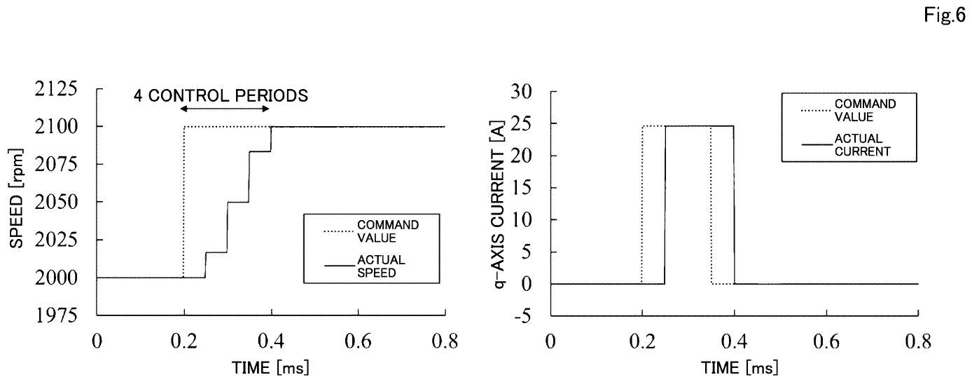

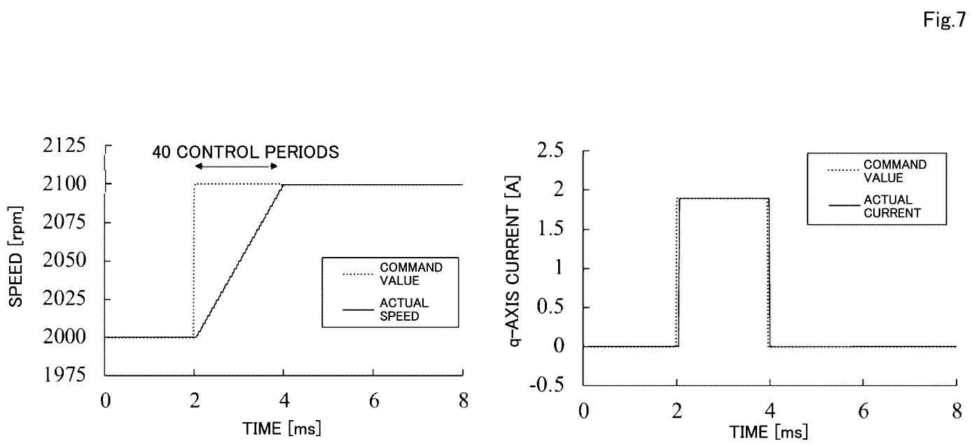

Next, the result of a simulation about the DB speed control in the embodiment with use of MATLAB® and Simulink® of The MathWorks, Inc. will be shown. Specifications and others of the used PMSM are shown in FIG. 5, as the condition of the simulation. For simplification, the PMSM had no load, the disturbance observer 15 was excluded, the carrier frequency was 10 kHz, the speed control period was 50 μs, and n_{c} was 4 or 40. In the case of n_{c}=4 shown in FIG. 6, the following time by the speed step response was 0.2 ms, and in the case of n_{c}=40 shown in FIG. 7, the following time by the speed step response was 2 ms. The following time is a time until the deviation between the command value and the actual speed becomes less than or equal to 5% of 100 rpm, which is a speed step width. In this way, in the embodiment, it is possible to follow the speed in any control period.

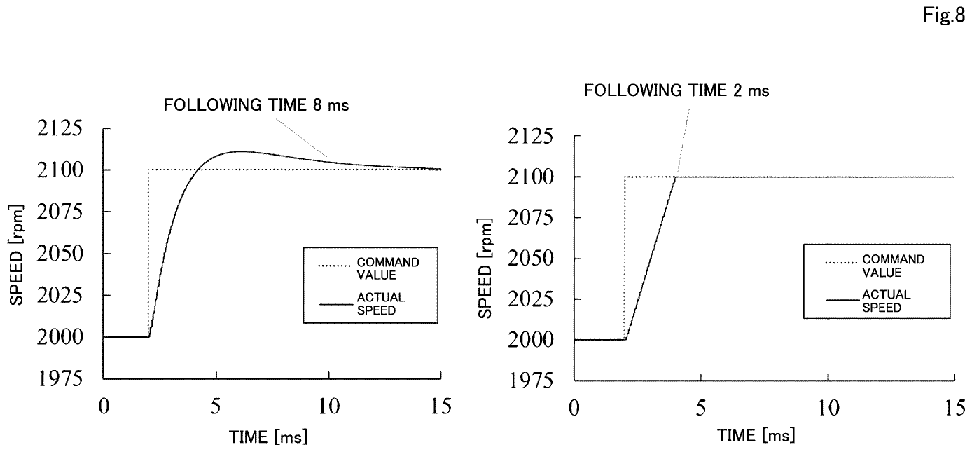

Further, FIG. 8 shows a speed step response by a conventional PI (Proportional-Integral) control and a speed step response by the embodiment in the case of n_{c}=40, in a side-by-side manner. The following time in the former is 8 ms, and the following time in the latter is 2 ms. Therefore, the following time for the speed is shorter than that in the related art.

As described above, in the embodiment, the inverter 6 converts direct-current power into alternating-current power and supplies the alternating-current power to the PMSM 11, and the current detector 7 detects the respective phase currents iu, iv, and iw that are supplied to the PMSM 11. The speed calculator 14 calculates and detects the speed of the PMSM 11 from the A-phase and B-phase signals that are input by the rotary encoder 12, and the controller 18 controls the turning-on and turning-off of the plurality of semiconductor switching elements constituting the inverter 6.

Moreover, the controller 18 includes the speed controller 1 that outputs the acceleration component i_{qA*} of the q-axis command current to the adder 2, based on the deviation between the input command speed @ and the speed what detected by the speed calculator 14, and the current controller 3 that generates the command voltages V_{q} and V_{d} based on the deviation between the command current i_{q*} output from the adder 2 and the detected current i_{q}.

The speed controller 1 computes, for each control period, the command current i_{qA*} for causing the speed what of the PMSM 11 to follow a target speed in a control period after a plurality of control periods from the present control period, by evaluating the sum of the command current computed last time and the adjustment current computed this time, and outputs the command current i_{qA*} to the current controller 3. In this configuration, it is possible to apply the DB control to the speed control of the PMSM 11, and it is possible to improve the speed response characteristic compared to the conventionally applied PI control.

### Second Embodiment

Hereinafter, the same portions as those in the first embodiment are denoted by the same reference characters, descriptions thereof will be omitted, and different portions will be described. In the first embodiment, in the column vector of the adjustment current vector shown in Expression (18), all elements are “1”. This indicates that the window function is a rectangular window. The total number of all elements is set to (n_{c}−1). That is, when a column vector W in which elements are weighted by values of the window function is defined as Expression (21), Expression (18) is expressed as Expression (22) as shown.

$$\begin{matrix}[ Formula 20 ] & \\ w = {[ {w}_{1} ⋯ {w}_{n} ⋯ {w}_{{n}_{c} - 1} ]}^{T} & \# ( 21 )\end{matrix}$$

$${i}_{k}^{qadj} = {\sum }_{n = 1}^{{n}_{c} - 1} {i}_{k + n \vert k}^{qadj} \frac{1}{{n}_{c} - 1} w \qquad \# ( 22 )$$

In addition, when the window function is, for example, a Hamming window, the function is expressed as Expression (23).

$$w ( x ) = 0.54 - 0.46 cos ( 2 π x ) , 0 \leq \times \leq 1 \qquad \# ( 23 )$$

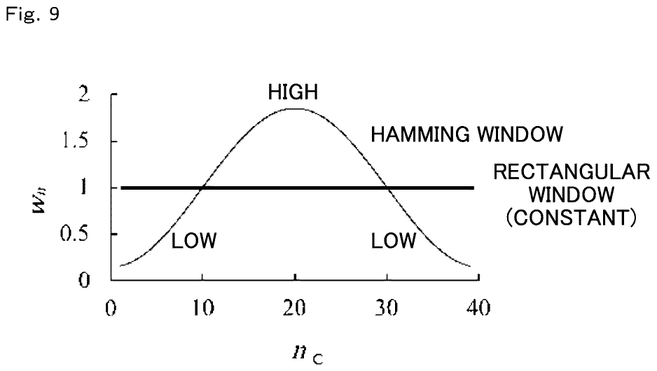

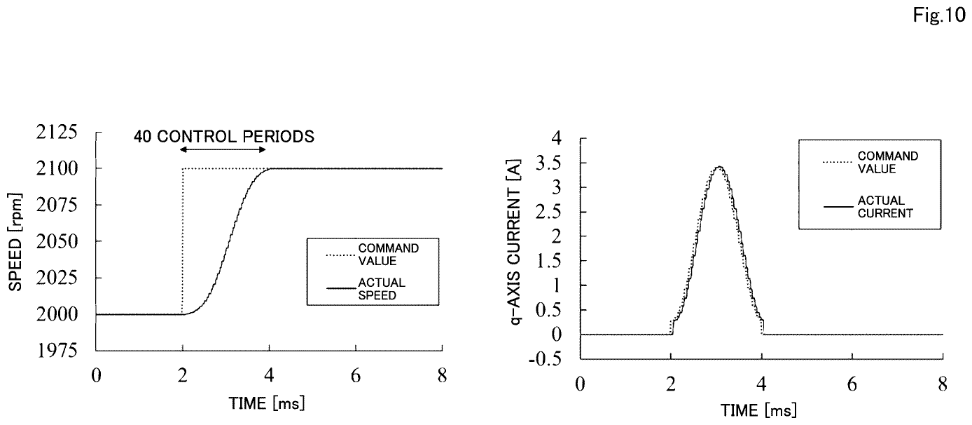

FIG. 9 shows the case where the window function is the rectangular window and the case where the window function is the Hamming function in the case of n_{c}=40. FIG. 10 shows a speed step response in the case where the window function is the Hamming window in the case of n_{c}=40. By applying the column vector W including the (n_{c}−1) elements that are weighted by values of an appropriately selected window function in this way, it is possible to reflect a characteristic depending on the window function, in the speed response characteristic.

### OTHER EMBODIMENTS

The value of n_{c} is not limited to “4” or “40”, and may be appropriately altered depending on an individual design.

The window function that is applied is not limited to the rectangular window or the Hamming window.

The carrier frequency, the speed control period, the motor constants, and the like may be appropriately altered for the execution.

In the current controller, the DB control does not always need to be applied, and the PI control may be applied.

Some embodiments of the present invention have been described. The embodiments have been presented as examples, and are not intended to limit the scope of the invention. The novel embodiments can be carried out in various other modes, and a variety of exclusions, replacements, and alterations can be performed without departing from the gist of the invention. The embodiments and modifications thereof are included in the scope and gist of the invention, and are included in scopes equivalent to the invention described in the claims.

1. A motor speed control device comprising:
an electric power converter that includes a plurality of semiconductor switching elements and that converts direct-current power into alternating-current power to supply the alternating-current power to an alternating-current motor;
a current detector that detects a current that is supplied to the alternating-current motor;
a speed detector that detects a speed of the alternating-current motor; and
a controller that controls turning-on and turning-off of the plurality of semiconductor switching elements, wherein:
the controller includes
a speed controller that generates a command current based on a deviation between an input command speed and the detected speed, and
a current controller that generates a command voltage based on a deviation between the command current and the detected current; and
the speed controller computes a command current for each control period and outputs the command current to the current controller, the command current being a command current for causing the speed of the alternating-current motor to follow a target speed in a control period after a plurality of control periods from a present control period, and being computed by evaluating a sum of a command current computed last time and an adjustment current computed this time.

2. The motor speed control device according to claim 1, wherein
the current controller computes a command voltage for causing the deviation between the command current and the detected current to become zero, from the present control period to a next control period, and outputs the command voltage.

3. The motor speed control device according to claim 1, wherein:
the speed controller evaluates the command current as a vector sum of the command current computed last time and the adjustment current; and
when the number of the plurality of control periods is nc, a vector matrix for the adjustment current is constituted by first to (nc−1)-th elements to each of which a weighting corresponding to a predetermined window function is given.
